(19) United States
(12) Patent Application Publication
(10) Pub. No.: US 2026/0055586 A1
(43) Pub. Date: Feb. 26, 2026

(54) SWITCHING DEVICE OF FLUID VALVE

(71) Applicants: Chia-Wei Chiang, Taichung City (TW); John-Adam Courtney, Taichung City (TW)

(72) Inventors: Chia-Wei Chiang, Taichung City (TW); John-Adam Courtney, Taichung City (TW)

(21) Appl. No.: 18/812,927

(22) Filed: Aug. 22, 2024

(51) Int. Cl. E03C 1/05; F16K 31/02

(52) U.S. Cl. CPC E03C 1/055; F16K 31/02; E03C 2201/30; E03C 2201/40

(57) ABSTRACT

A switching device of a fluid valvecontains: a fluid processor including a fluid input tube and a fluid output tube. The fluid input tube includes a fluid switching valvewith a connector, a first tube and a second tube. The connector has a constant-pressure channel communicating with the first tube and the second tube, and the fluid switching valve includes two pulse valves corresponding to the first tube and the second tube and controlled by Radio Frequency. When the second tube is turned on, the first tube is turned off so that the fluid fluids are guided into the fluid processor to be processed, then the fluids flow outward via the fluid output tube. When the first tube is turned on and the second tube is turned off, the fluids are not guided into the fluid processor and flow out the first tube directly.

### TECHNICAL FIELD

The present invention relates toa switch device of a fluid valve, and more particularly to a fluid switching valve.

### BACKGROUND

U.S. Patent No. U.S. Pat. No. 10,675,573 B2 and Chinese Publication No. CN 105817070 A disclosed a remotely controlled faucet filter system is configured toprovide a faucet screening program system, connected to the water supply pipeline, and includes: a manifold connected to the supply line and communicating with the supply line and a screening program device in fluid communication with the manifold. At least one remotely actuated valve is coupled to the manifold and configured for controlling flow of water in the manifold to the screening program device when filtered water is required. A wireless controller is disposed remotely from the screening program device and the manifold and configured for actuating the valve between a first position and a second position. In a first position, water flows from the water supply line through the faucet inlet, and in a second position, water flows from the water supply line to the screening program device and through the screening program outlet and flows through the faucet inlet. Depending on actuation of the valve, either filtered or unfiltered water is discharged through the faucet spout.

However, such a remotely controlled faucet filter system has defects as follows:
1. This remote-actuated valve cannot be modularized, the structure of the components is complex, the parts are not easy to obtain, and the mold must be remade. At the same time, the assembly and construction is very cumbersome and difficult, which is both time-consuming and labor-intensive.
2. The remotely controlled faucet filter system is only suitable for kitchens. It has a narrow scope of application and cannot provide multiple indoor and outdoor uses.
3. Maintenance of remotely controlled faucet filter system is difficult, both disassembly and assembly require professionals. The cost is high and it is not competitive.

The present invention has arisen to mitigate and/or obviate the afore-described disadvantages.

### SUMMARY

The primary aspect of the present invention is to provide a switching device of a fluid valvewhich is controlled remotely by Radio Frequency (RF) or is manually controlled by one or multiple buttons to turn on/off the first tube and the second tube of the fluid switching valve.

Another aspect of the present invention is to provide a switching device of a fluid valve which is modularized and simplified to reduce fabrication cost and to be connected easily, thus saving connection time and labor.

To obtain above-mentioned aspect, a switching device of a fluid valve provided by the present invention contains: a fluid processor including a fluid input tube and a fluid output tube. The fluid input tube includes a fluid switching valve which comprises a connector, a first tube and a second tube connected with the fluid input tube, the connector has a constant-pressure channel communicating with the first tube and the second tube, and the fluid switching valve includes two pulse valves corresponding to the first tube and the second tube and controlled by Radio Frequency.

When the second tube is turned on, the first tube is turned off so that the fluids are guided into the fluid processor to be processed, then the fluids flow outward via the fluid output tube.

When the first tube is turned on and the second tube is turned off, the fluids are not guided into the fluid processor and flow out the first tube directly.

Preferably, the fluid processor is supplied power by a battery or direct currents (DC) or by the battery and the DC.

Preferably, the fluid processor is any one of a filterand a cooler.

Preferably, the fluid output tube has a Tee tube which is connected with a faucet and the first tube.

Preferably, the fluid output tube of the fluid processor is connected with a second tube of another fluid switching valve, and the first tube of the fluid switching valve is connected with a first tube of another fluid switching valve.

Preferably, the fluid processor is fixed on a camper vanfor drinking water application.

Preferably, thefluid processoris fixed in a kitchen or bathroom equipment.

Preferably, the fluid switching valve includes a first work light and a second work light which are configured to emit lights when turning on the first tube and the second tube.

Preferably, the two pulse valves are manually controlled by usingone or multiple buttons.

### BRIEF DESCRIPTION OF THE DRAWINGS

FIG. 1 is a perspective view showing the assembly of a fluid switching valve according to a preferred embodiment of the present invention.

FIG. 2 is a perspective view showing the exploded components of the fluid switching valve according to thepreferred embodiment of the present invention.

FIG. 3 is a plan view showing the assembly of the fluid switching valve according to thepreferred embodiment of the present invention.

FIG. 4 is a cross sectional view taken along the line B-B of FIG. 3.

FIG. 5 is a cross sectional view taken along the line E-E of FIG. 4.

FIG. 6 is a cross sectional view taken along the line N-N of FIG. 4.

FIG. 7 is a cross sectional view showing the operation of a first pipe arrangement of the fluid switching valve according to thepreferred embodiment of the present invention.

FIG. 8 is a cross sectional view showing the operation of a second pipe arrangement of the fluid switching valve according to thepreferred embodiment of the present invention.

FIG. 9 is a block diagram showing the operation of a microcontroller to transmit data according to the preferred embodiment of the present invention.

FIG. 10 is a block diagram showing the operation of the microcontroller to receive the data according to the preferred embodiment of the present invention.

FIG. 11 is a schematic view showing the application of the fluid switching valve working with a fluid processor and connecting to a faucet according to thepreferred embodiment of the present invention.

FIG. 12 is a schematic view showing the application of the fluid switching valvenotworking with a fluid processor and connecting to a faucet according to thepreferred embodiment of the present invention.

FIG. 13 is a schematic view showing another application of multiplefluid switching valves working in a water treatment systemaccording to thepreferred embodiment of the present invention

FIG. 14 is a schematic view showing another application of multiplefluid switching valves notworking in a water treatment system according to thepreferred embodiment of the present invention

FIG. 15 is a schematic view showing another application of thefluid switching valves working with a fluid processor in the camper van according to thepreferred embodiment of the present invention

### DETAILED DESCRIPTION

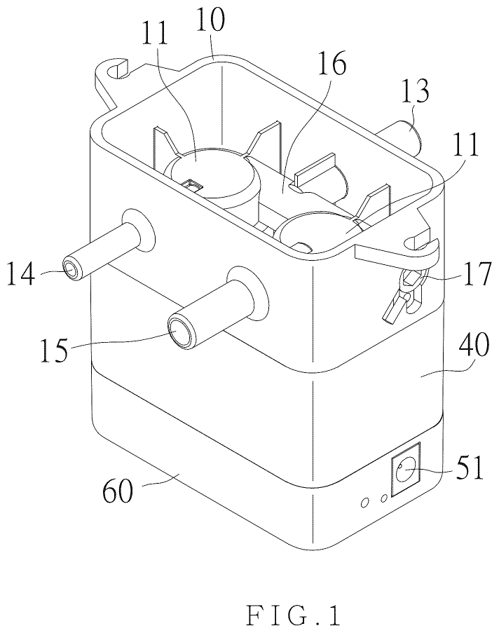

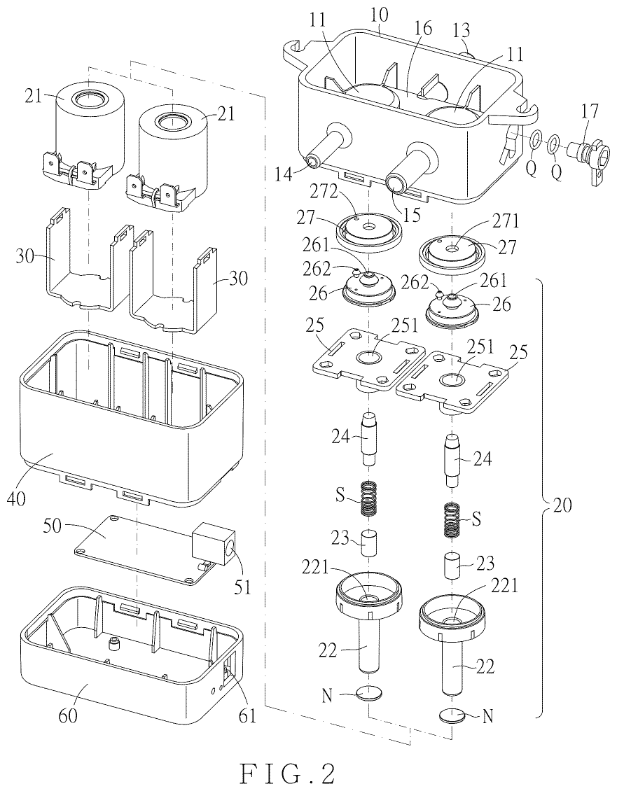

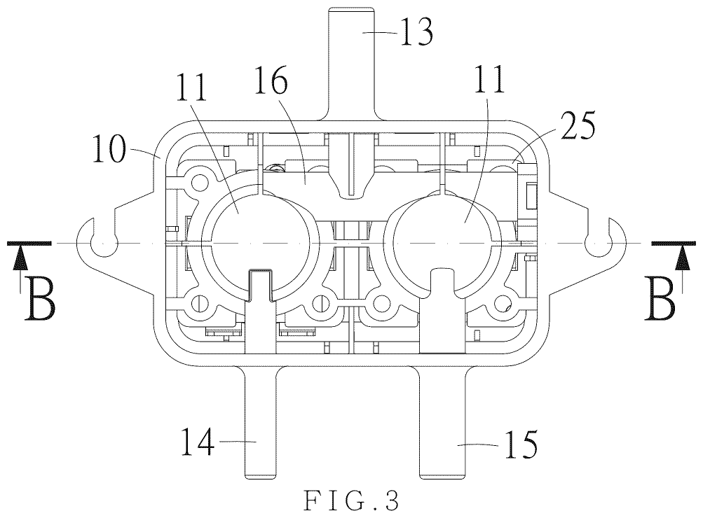

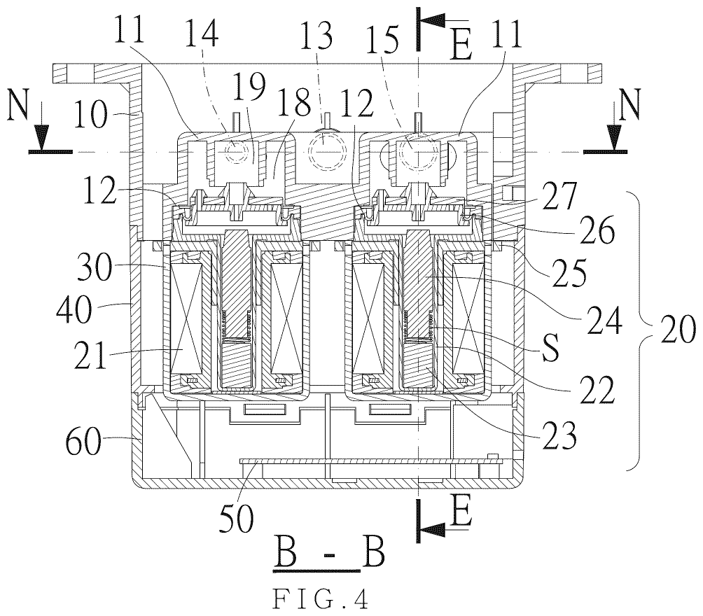

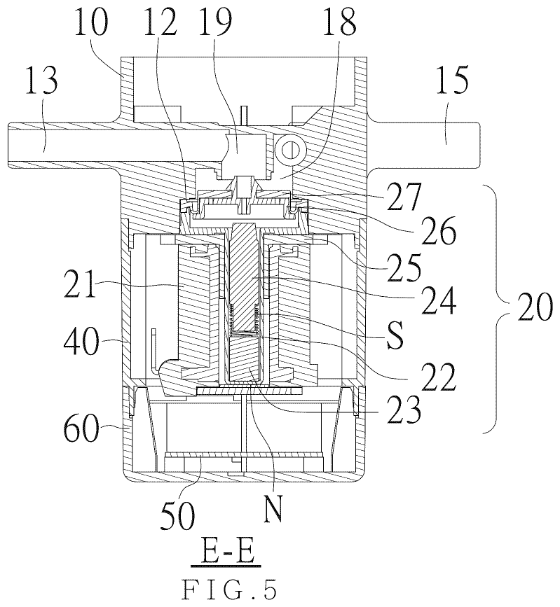

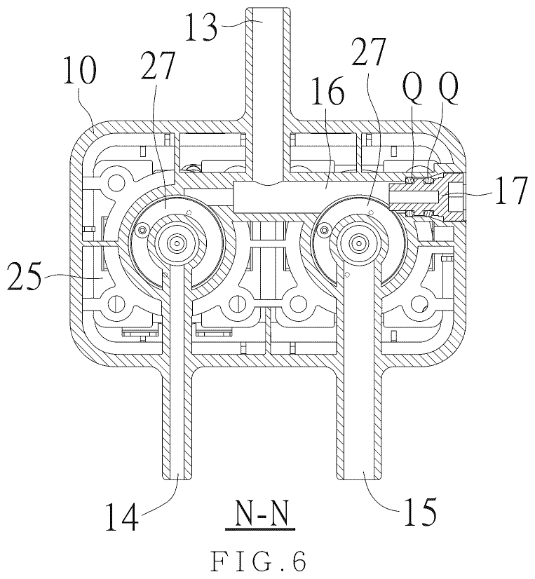

FIG. 1 is a perspective view showing the assembly of a fluid switching valveaccording to a preferred embodiment of the present invention. FIG. 2 is a perspective view showing the exploded components of the fluid switching valveaccording to thepreferred embodiment of the present invention. FIG. 3 is a plan view showing the assembly of the fluid switching valveaccording to thepreferred embodiment of the present invention. FIG. 4 is a cross sectional view taken along the line B-B of FIG. 3. FIG. 5 is a cross sectional view taken along the line E-E of FIG. 4. FIG. 6 is a cross sectional view taken along the line N-N of FIG. 4. The fluid switching valve comprises: a base 10, two pulse valves 20, two holders 30, a body 40, an integrated circuit board50, and a cap 60.

The base 10 includes two receiving orifices 11 vertically defined on two sides thereof, wherein a respective one receiving orifice 11 is a spot-faced hole and has a shoulder 12, and the respective one receiving orifice 11 is configured to receive a respective one pulse valve 20. The base 10 also includes a connector 13 horizontally fixed on a front end thereof and between the two receiving orifices 11, a first tube 14 and a second tube 15 connected on two sides of a rear end of the base 10 and corresponding to the two receiving orifices 11, a constant-pressure channel 16 communicating with the first tube 14 and the second tube 15, a plug element P received in an opening of the constant-pressure channel 16, two seal rings Q fitted on the plug element P to close the opening of the constant-pressure channel 16, two discharge orifices 17 corresponding to the first tube 14 and the second tube 15, a depressurizing chamber 18 defined outside the two discharge orifices 17, and an air chamber 19 formed in the two discharge orifices 17.

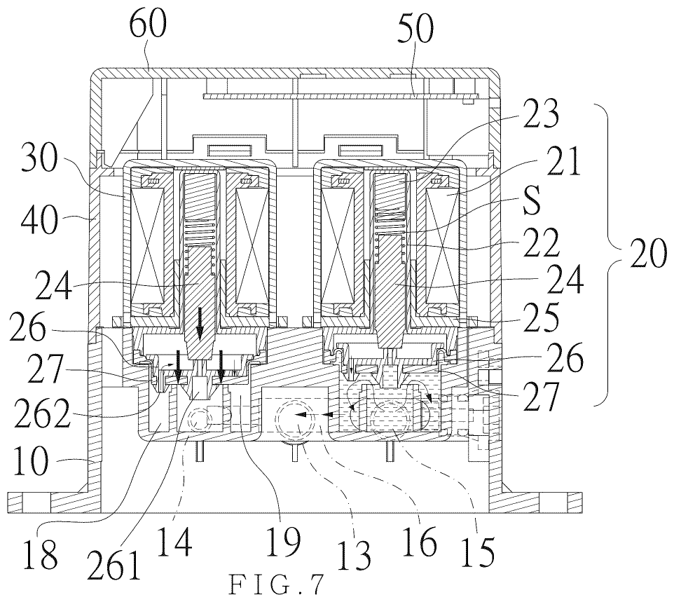

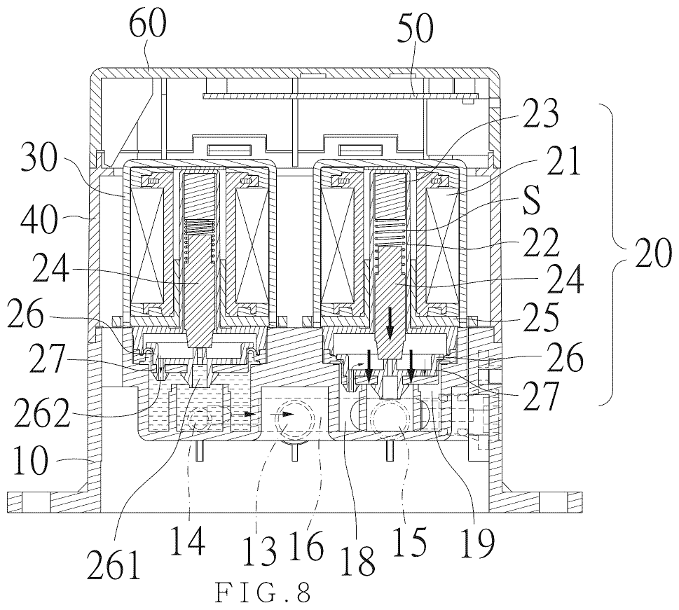

The respective one pulse valve 20 includes an induction coil 21, a fitting sleeve 22, a magnetic element 23, a resilient element S, a valve core 24, a connection sheet 25, a seat 26, a film 27, and a washer N. The induction coil 21 has the washer N and the fitting sleeve 22 which are fixed on a center of the induction coil 21, a hollow column 221 extending from a center of the fitting sleeve 22 and configured to receive the magnetic element 23, the resilient element S, and the valve core 24, wherein the connection sheet 25 has a hollow extension 251 extending from a center thereof and configured to fit with the hollow column 221, the seat 26 is made of flexible material and has a hook 261 extending from a center thereof, a throttle element 262 extending from a side of the seat 26 in a hook shape, the film 27 is engaged on a shoulder 12 of the respective one receiving orifice 11, and the film 27 is made of flexible material, the film 27 has a first coupling orifice 271 defined on a center thereof and corresponding to the hook 261 so that the hook 261 extends out of the first coupling orifice 271, a second coupling orifice 272 formed on a side of the film 27 and corresponding to the throttle element 262 so that the throttle element 262 extends out of the second coupling element 262. FIG. 7 is a cross sectional view showing the operation of a first pipe arrangement of the fluid switching valve according to thepreferred embodiment of the present invention. FIG. 8 is a cross sectional view showing the operation of a second pipe arrangement of the fluid switching valve according to thepreferred embodiment of the present invention. When the induction coil 21 of the respective one pulse valve 20 is not excited by power, the induction coil 21 is forced by the resilient element D to move downward so that the valve core 24 actuates the seat 26 and the film 27 to block a discharge orifice 17, and a pressure of the depressurizing chamber 18 is equal to a pressure of the air chamber 19, so fluids do not flow outward. When the induction coil 21 of the respective one pulse valve 20 is excited by the power, the valve core 24 is pushed by an electromagnetic force to lift upward, and the discharge orifice 17 is opened. Then, the pressure of the depressurizing chamber 18 is lower than the pressure of the air chamber 19 by using the constant-pressure channel 16 and the throttle element 262 so that the fluids in the air chamber 19 push the film 27 upward to open the discharge orifice 17, thus flowing the fluids out of the discharge orifice 17.

A respective one holder 30 is in an inverted U shape and is inserted on the connection sheet 25 to support the respective one pulse valve 20.

The body 40 is a hollow frame and the cap 60 is fixed on the base 10 to accommodate the two pulse valves 20.

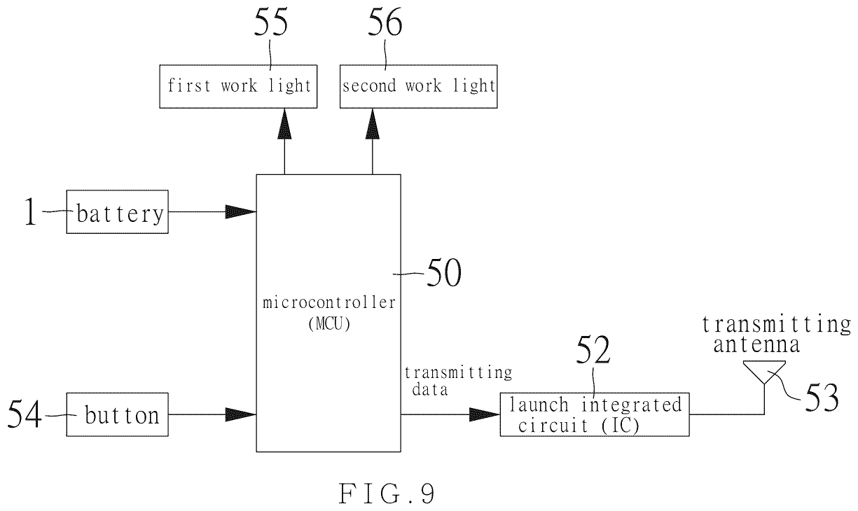

FIG. 9 is a block diagram showing the operation of a microcontroller to transmit data according to the preferred embodiment of the present invention.

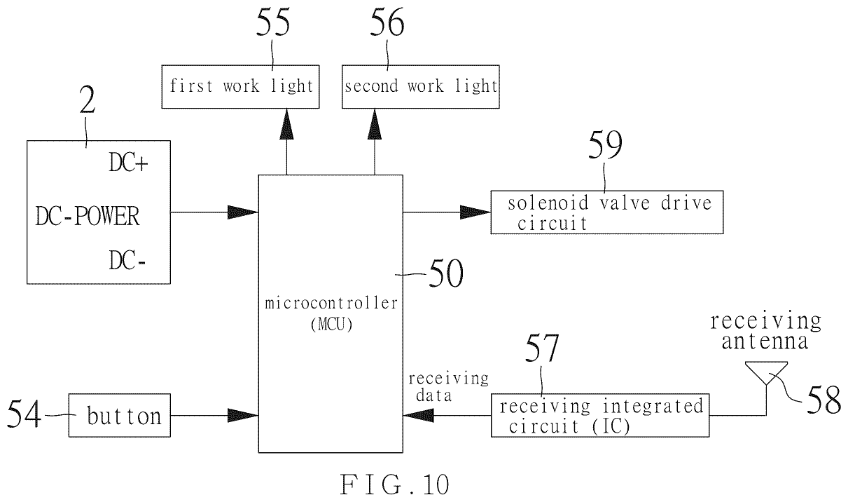

FIG. 10 is a block diagram showing the operation of the microcontroller to receive the data according to the preferred embodiment of the present invention. The integrated circuit board 50 includes a microcontroller (MCU), wherein the integrated circuit board 50 is electrically connected with the induction coil 21 of the respective one pulse valve 20 and includes a power input hole 51 defined on an outer wall thereof, a launch integrated circuit (IC) 52, a transmitting antenna 53, a button 54, a first work light 55, a second work light 56, a receiving integrated circuit (IC) 57, a receiving antenna 58, and a solenoid valve drive circuit 59. When the first tube 14 or the second tube 15 is turned on, the first work light 55 and the second work light 56 emit lights, the integrated circuit board 50 selectssupplies power by a battery 1 or DC alternating current 2. The transmitting antenna 53 and the receiving antenna 58 of the integrated circuit board 50 are controlled remotely by Radio Frequency 3 (RF) and receive an on signal or an off signal.

The cap 60 is disposed on the body 40 to accommodate the integrated circuit board 50, wherein the cap 60 includes a mouth 61 configured to connect with the power input hole 51.

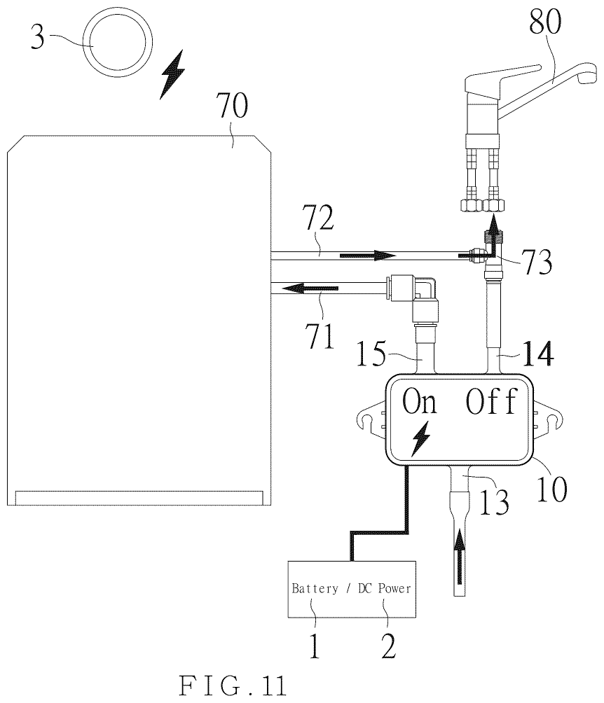

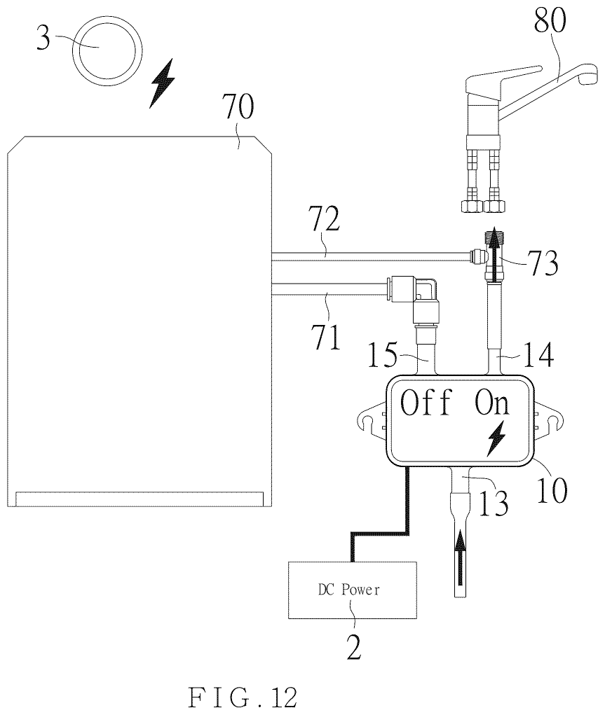

FIG. 11 is a schematic view showing the application of the fluid switching valve according to thepreferred embodiment of the present invention. FIG. 12 is another schematic view showing the application of the fluid switching valve according to thepreferred embodiment of the present invention. The fluid switching valve is applicable for a faucet, wherein a fluid processor 70 is supplied the power by a battery 1 or direct currents (DC) 2. Alternatively, the fluid processor 70 is supplied the power by the battery 1 and the DC 2. The fluid processor 70 is any one of a filter, and a cooler. The fluid processor 70 includes a fluid input tube 72 and a fluid output tube 72, wherein fluid input tube 71 is connected with the second tube 15 of the base 10, the fluid output tube 72 has a Tee tube 73 which is connected with the first tube 14 and the faucet 80. Radio Frequency 3 is controlled remotely to turn on the second tube 15 and to turn off the first tube 14 so that the fluids are guided into the fluid processor 70 via the fluid input tube 71 to be processed, then the fluids flow out of the faucet 80 via the fluid output tube 72 and the Tee tube 73, as shown in FIG. 11. The radio frequency 3 is controlled remotely to turn on the first tube 14 and to turn off the second tube 15 so that the fluids are not guided into the fluid processor 70, and the fluids flow out of the faucet 80 via the Tee tube 73, as shown in FIG. 12.

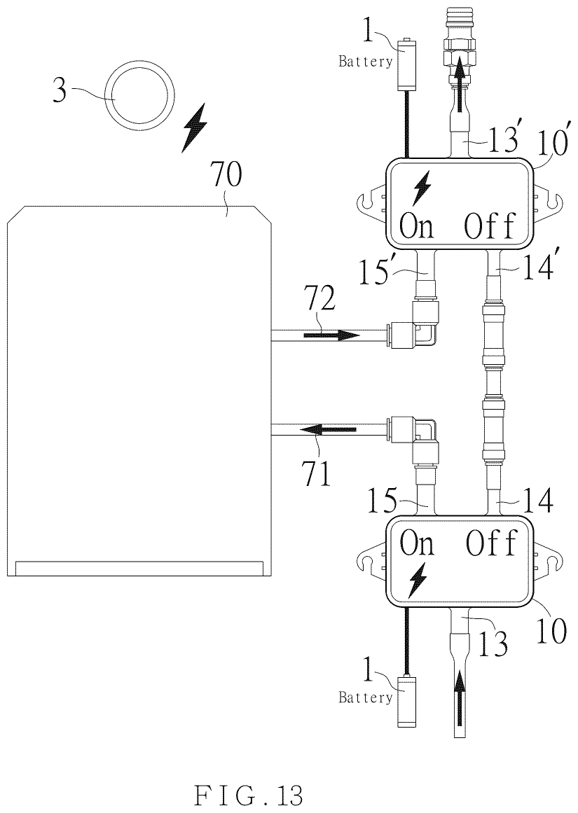

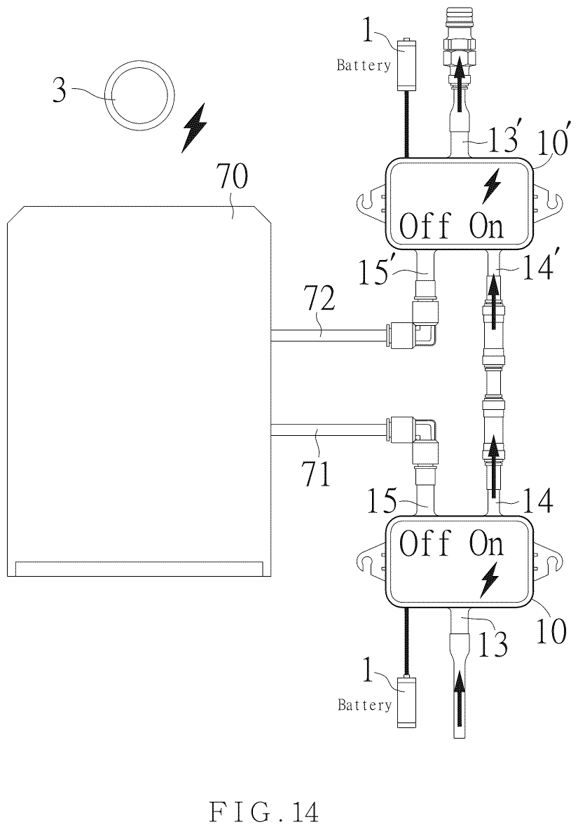

FIG. 13 is a schematic view showing another application of the fluid switching valve according to thepreferred embodiment of the present invention. FIG. 14 is another schematic view showing another application of the fluid switching valve according to thepreferred embodiment of the present invention. The fluid switching valve is applicable for a tube arrangement, wherein the fluid processor 70 is supplied power by a battery 1 or direct currents (DC) 2. Alternatively, the fluid processor 70 is supplied the power by the battery 1 and the DC 2. The fluid processor 70 is any one of a filter and a cooler. The fluid processor 70 includes a fluid input tube 72 and a fluid output tube 72, wherein fluid input tube 71 is connected with the second tube 15 of the base 10, the fluid output tube 72 is connected with a second tube 15′ of another base 10′. The first tube 14 of the base 10 is connected with a first tube 14′ of another base 10′, wherein Radio Frequency 3 is controlled remotely to turn on the second tubes 15, 15′ and to turn off the first tubes 14, 14′ so that the fluids are guided into the fluid processor 70 via the fluid input tube 71 to be processed, then the fluids flow out of the connector 13′ via the fluid output tube 72 and the second tube 15′, as shown in FIG. 13. The radio frequency 3 is controlled remotely to turn on the first tubes 14, 14′ and to turn off the second tubes 15, 15′ so that the fluids are not guided into the fluid processor 70, and the fluids flow out of the connector 13′ via the first tubes14, 14′, as shown in FIG. 14.

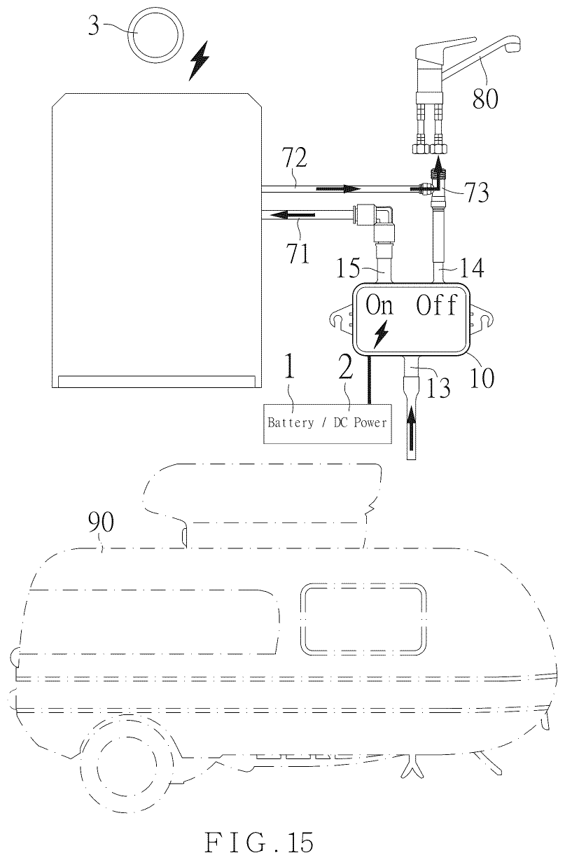

FIG. 15 is a schematic view showing the other application of the fluid switching valve according to thepreferred embodiment of the present invention. The fluid switching valve is applicable for a faucet fixed on a camper van, wherein the camper van 90 is supplied the power by a battery 1 or direct currents (DC) 2. Alternatively, the fluid processor 70 is supplied power by the battery 1 and the DC 2. The camper van 90 includes a fluid processor 70 which is any one of a filterand a cooler. The fluid processor 70 includes a fluid input tube 72 and a fluid output tube 72, wherein fluid input tube 71 is connected with the second tube 15 of the base 10, the fluid output tube 72 has a Tee tube 73 which is connected with the first tube 14 and the faucet 80. Radio Frequency 3 is controlled remotely to turn on the second tube 15 and to turn off the first tube 14 so that the fluids are guided into the fluid processor 70 via the fluid input tube 71 to be processed, then the fluids flow out of the faucet 80 via the fluid output tube 72 and the Tee tube 73.

While the first embodiments of the invention have been set forth for the purpose of disclosure, modifications of the disclosed embodiments of the invention as well as other embodiments thereof may occur to those skilled in the art. The scope of the claims should not be limited by the first embodiments set forth in the examples but should be given the broadest interpretation consistent with the description as a whole.

1. A switching device of a fluid valve comprising:
a fluid processor including a fluid input tube and a fluid output tube, wherein the fluid input tube includes a fluid switching valve comprising a connector, a first tube and a second tube;
wherein the second tube is connected with the fluid input tube;
wherein the connector includes a constant-pressure channel communicating with the first tube and the second tube;
wherein the fluid switching valve includes two pulse valves respectively corresponding to the first tube and the second tube and controlled by Radio Frequency (RF);
wherein when the second tube is turned on, the first tube is turned off so that the fluids are guided into the fluid processor to be processed and then flow outward via the fluid output tube;
wherein when the first tube is turned on and the second tube is turned off, the fluids are not guided into the fluid processor and flow out through the first tube directly;
wherein the fluid processor is supplied power by a battery or direct current (DC), or by both the battery and the DC;
wherein the fluid output tube includes a Tee tube connected with a faucet and the first tube; and
wherein the fluid processor is installed in an indoor kitchen/bathroom device or mounted on an outdoor camper van.

2. The switching device as claimed in claim 1, wherein the fluid processor is any one of a filter and a cooler.

3. The switching device of a fluid valve as claimed in claim 1, wherein the fluid output tube of the fluid processor is connected with a second tube of another fluid switching valve, and the first tube of the fluid switching valve is connected with a first tube of another fluid switching valve.

4. The switching device of a fluid valve as claimed in claim 1, wherein the fluid switching valve includes a first work light and a second work light configured to emit lights when turning on the first tube and the second tube.

5. The switching device of a fluid valve as claimed in claim 1, wherein the two pulse valves are manually controlled by one or multiple buttons.

6. (canceled)

7. (canceled)

8. (canceled)

9. (canceled)
